(19) United States
(12) Patent Application Publication
(10) Pub. No.: US 2008/0293329 A1
(43) Pub. Date: Nov. 27, 2008

(54) METHODS AND APPARATUS FOR IDENTIFYING A SUBSTRATE EDGE PROFILE AND ADJUSTING THE PROCESSING OF THE SUBSTRATE ACCORDING TO THE IDENTIFIED EDGE PROFILE

(75) Inventor: Paul V. Miller, Cupertino, CA (US)

Correspondence Address: DUGAN & DUGAN, PC, 245 Saw Mill River Road, Suite 309, Hawthorne, NY, 10532, US

(73) Assignee: APPLIED MATERIALS, INC., Santa Clara, CA (US)

(21) Appl. No.: 12/125,038

(22) Filed: May 21, 2008

Related U.S. Application Data
(60) Provisional application No. 60/939,212, filed on May 21, 2007.

(51) Int. Cl. B24B 51/00; G06F 19/00

(52) U.S. Cl. 451/5; 700/121

(57) ABSTRACT

Methods, apparatus and systems are provided for processing a selected substrate having an edge profile. The invention includes receiving substrate information at a substrate processing system wherein the substrate information is associated with at least one substrate; determining an identification code of a substrate selected for processing using the received substrate information; accessing edge profile information associated with the selected substrate from the received substrate information using the identification code of the selected substrate; and determining a processing recipe for the selected substrate based on the accessed edge profile information. Numerous other aspects are provided.

The present application claims priority from U.S. Provisional Patent Application Ser. No. 60/939,212, filed May 21, 2007, entitled “METHODS AND APPARATUS FOR IDENTIFYING A SUBSTRATE EDGE PROFILE AND ADJUSTING THE PROCESSING OF THE SUBSTRATE ACCORDING TO THE IDENTIFIED EDGE PROFILE” (Attorney Docket No. 11695/L) which is hereby incorporated herein by reference in its entirety for all purposes.

### CROSS-REFERENCE TO RELATED APPLICATIONS

The present application is related to the following commonly-assigned, co-pending U.S. patent applications, each of which is hereby incorporated herein by reference in its entirety for all purposes:

U.S. patent application Ser. No. 10/440,937 filed May 19, 2003, entitled “TEST SUBSTRATE RECLAMATION METHOD AND APPARATUS” issued as U.S. Pat. No. 6,954,711 on Oct. 11, 2005;

U.S. patent application Ser. No. 11/299,295 filed on Dec. 9, 2005, and entitled “METHODS AND APPARATUS FOR PROCESSING A SUBSTRATE” (Attorney Docket No. 10121);

U.S. patent application Ser. No. 11/298,555 filed on Dec. 9, 2005, and entitled “METHODS AND APPARATUS FOR PROCESSING A SUBSTRATE” (Attorney Docket No. 10414);

U.S. patent application Ser. No. 10/286,404 filed on Nov. 1, 2002, and entitled “SINGLE WAFER DRYING AND DRYING METHODS” (Attorney Docket No. 5877);

U.S. patent application Ser. No. 10/650,310 filed on Aug. 28, 2003, and entitled “SYSTEM FOR TRANSPORTING SUBSTRATE CARRIERS” (Attorney Docket No. 6900);

U.S. patent application Ser. No. 10/650,479 filed on Aug. 28, 2003, and entitled “METHOD AND APPARATUS FOR SUPPLYING SUBSTRATES TO A PROCESSING TOOL” (Attorney Docket No. 7096);

U.S. patent application Ser. No. 10/764,982 filed on Jan. 26, 2004, and entitled “METHODS AND APPARATUS FOR TRANSPORTING SUBSTRATE CARRIERS” (Attorney Docket No. 7163);

U.S. Patent Application Ser. No. 60/882,066 filed on Dec. 27, 2006, and entitled “SYSTEMS AND METHODS FOR MODULAR AND CONFIGURABLE SUBSTRATE CLEANING” (Attorney Docket No. 10860/L);

U.S. Patent Application Ser. No. 60/939,351, filed May 21, 2007, entitled “METHODS AND APPARATUS FOR POLISHING A NOTCH OF A SUBSTRATE USING AN INFLATABLE POLISHING WHEEL” (Attorney Docket No. 10674/L);

U.S. Patent Application Ser. No. 60/939,353, filed May 21, 2007, entitled “METHODS AND APPARATUS FOR FINDING A SUBSTRATE NOTCH CENTER” (Attorney Docket No. 11244/L);

U.S. Patent Application Ser. No. 60/939,343, filed May 21, 2007, entitled “METHODS AND APPARATUS TO CONTROL SUBSTRATE BEVEL AND EDGE POLISHING PROFILES OF EPITAXIAL FILMS” (Attorney Docket No. 11417/L);

U.S. Patent Application Ser. No. 60/939,219, filed May 21, 2007, entitled “METHODS AND APPARATUS FOR POLISHING A NOTCH OF A SUBSTRATE USING A SHAPED BACKING PAD” (Attorney Docket No. 11483/L);

U.S. Patent Application Ser. No. 60/939,342, filed May 21, 2007, entitled “METHODS AND APPARATUS FOR REMOVAL OF FILMS AND FLAKES FROM THE EDGE OF BOTH SIDES OF A SUBSTRATE USING BACKING PADS” (Attorney Docket No. 11564/L);

U.S. Patent Application Ser. No. 60/939,350 filed May 21, 2007, entitled “METHODS AND APPARATUS FOR USING A BEVEL POLISHING HEAD WITH AN EFFICIENT TAPE ROUTING ARRANGEMENT” (Attorney Docket No. 11565/L);

U.S. Patent Application Ser. No. 60/939,344, filed May 21, 2007, entitled “METHODS AND APPARATUS FOR USING A ROLLING BACKING PAD FOR SUBSTRATE POLISHING” (Attorney Docket No. 11566/L);

U.S. Patent Application Ser. No. 60/939,333, filed May 21, 2007, entitled “METHODS AND APPARATUS FOR SUBSTRATE EDGE POLISHING USING A POLISHING ARM” (Attorney Docket No. 11567/L);

U.S. Patent Application Ser. No. 60/939,337, filed May 21, 2007, entitled “METHODS AND APPARATUS FOR HIGH PERFORMANCE SUBSTRATE BEVEL AND EDGE POLISHING IN SEMICONDUCTOR MANUFACTURE” (Attorney Docket No. 11809/L);

U.S. Patent Application Ser. No. 60/939,228, filed May 21, 2007, entitled “METHODS AND APPARATUS FOR POLISHING A NOTCH OF A SUBSTRATE BY SUBSTRATE VIBRATION” (Attorney Docket No. 11952/L); and

U.S. Patent Application Ser. No. 60/939,209, filed May 21, 2007, entitled “METHODS AND APPARATUS FOR CONTROLLING THE SIZE OF AN EDGE EXCLUSION ZONE OF A SUBSTRATE” (Attorney Docket No. 11987/L).

### FIELD OF THE INVENTION

The present invention relates generally to substrate processing, and more particularly to methods and apparatus determining the profile of an edge of a substrate and processing the substrate according to the determined profile.

### BACKGROUND OF THE INVENTION

Substrates used in electronic device manufacturing may be produced to differing specifications by substrate manufacturers. Relevant SEMI standard governing substrate parameters often provide wide tolerances, allowing considerable variation in the dimensions and profiles of edge portions of the substrate. For example, edge profiles (i.e., cross-sectional shapes of the edge of the substrate) may differ considerably by manufacturer. During subsequent processing steps, films may accumulate on the surfaces of the substrate, including the edge of the substrate. The residual films can become a source of defects, and it is thus advantageous to remove the residues by polishing the substrate edge without damaging or changing the shape of the substrate. Conventional edge polishing procedures may not adequately account for the variability in the edge profile of the substrate as provided by the manufacturer, and application of the conventional edge polishing procedures may result in inaccuracies and errors, such as changing the shape of the substrate's edge profile. What is therefore needed is a method and apparatus for accurately determining the edge profile of a substrate, and for adjusting polishing procedures accordingly.

### SUMMARY OF THE INVENTION

In a first aspect of the invention, a method of processing a selected substrate includes: (1) receiving substrate information at a substrate processing system, wherein the substrate information is associated with at least one substrate; (2) determining an identification code of a substrate selected for processing using the received substrate information; (3) retrieving the edge profile information associated with the selected substrate from the received substrate information using the identification code of the selected substrate; and (4) determining a processing recipe for the selected substrate based on the retrieved edge profile information.

In another aspect of the invention, a method of processing a substrate having an edge profile and an inscribed identification code includes: (1) receiving a substrate at a substrate processing system; (2) detecting the inscribed identification code of the substrate; (3) transmitting a request, including the identification code of the substrate, to access stored edge profile information associated with the substrate; (4) receiving the stored edge profile information associated with the substrate; and (5) determining a processing recipe for the substrate based on the edge profile information of the substrate.

In yet another aspect of the invention, a system for processing a substrate is provided. The system comprises an edge profile database containing substrate edge profile information; an edge polishing apparatus adapted to polish the edge of the substrate; and a controller adapted to receive the edge profile information from the edge profile database, and adapted to instruct the edge polishing apparatus to process the substrate edge in accordance with the edge profile information.

Other features and aspects of the present invention will become more fully apparent from the following detailed description, the appended claims and the accompanying drawings.

### BRIEF DESCRIPTION OF THE FIGURES

FIG. 1A is schematic cross-sectional view of an edge of a first exemplary substrate.

FIG. 1B is schematic cross-sectional view of an edge of a second exemplary substrate.

FIG. 1C is schematic cross-sectional views of an edge of a third exemplary substrate.

FIG. 2 is an illustration of a database including substrate edge profile information as provided in accordance with the present invention.

FIG. 3 is a plan view of an exemplary substrate cleaning and polishing system in accordance with the present invention.

FIG. 4 is a schematic plan view of an edge of a substrate depicting an inscribed substrate identification code in accordance with the present invention.

FIG. 5 is a flow chart of a first exemplary embodiment of a method of identifying an edge profile of a substrate and determining a suitable processing recipe in accordance with the present invention.

FIG. 6 is a flow chart of a second exemplary embodiment of a method of identifying an edge profile of a substrate and determining a suitable processing recipe in accordance with the present invention.

### DETAILED DESCRIPTION

The present invention provides improved methods and systems for polishing the edge of a substrate. As described above, if the various edge profiles of the substrates, provided by manufacturers, are not taken into account during edge polishing procedures, inaccuracies and errors may result. For example, too much material may be removed by the polishing process and/or portions of the edge may not be adequately polished. Therefore, the present invention provides a database including edge profile information associated with a particular substrate. Each substrate may have an identification code, through which the edge profile information may be indexed. Each substrate edge may be categorized by one or more node sections. For example, the interface of a major surface of the substrate and the edge of the substrate may be node 1 and the outer edge of the substrate may be node 2. The area of the substrate between node 1 and node 2 may be categorized as node section 1-2. The edge profile information may include, for example, information characterizing the shape, related to the length, related to the inclination angle, and related to the curvature of node section 1-2. A “recipe” for processing the substrate may be determined based on the edge profile information. The recipe may be transmitted to a processing tool such that the processing tool processes the substrate in accordance with the edge profile.

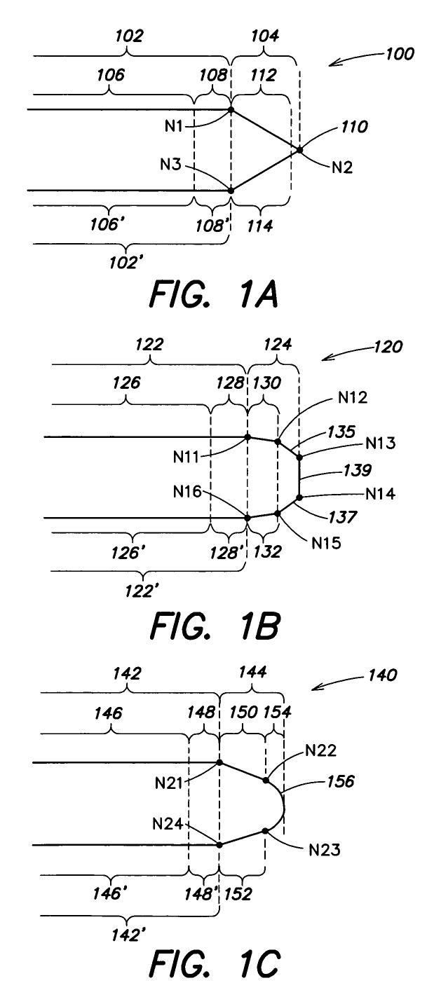

In electronic device manufacturing, one or more cleaning and/or polishing procedures, such as edge polishing, may be performed at one or more stages of a device fabrication process. The substrates upon which such procedures are performed may have a variety of different edge profiles as illustrated in FIGS. 1A, 1B and 1C.

FIG. 1A is a cross-sectional view of a first exemplary edge profile of a substrate 100. The substrate 100 may include two major surfaces 102, 102′ and an edge 104. Each major surface 102, 102′ of the substrate 100 may include a device region 106, 106′ upon which devices may be fabricated, and exclusion regions 108, 108′ (termed ‘edge exclusion zones’ herein) upon which device fabrication is not meant to occur. (Typically however, only one of the two major surfaces 102, 102′ will include a device region and an exclusion region). The edge exclusion zones 108, 108′ may serve as a buffer between the device regions 106, 106′ and the edge 104. The edge 104 of the substrate 100 may include an outer edge 110 and bevels 112, 114. The bevels 112, 114 may be located between the outer edge 110 and the exclusion regions 108, 108′ of the two major surfaces 102, 102′ and may have surfaces aligned at an angle with respect to the major surfaces 102, 102′. In an edge polishing process, the bevels 112, 114 and/or the edge exclusion zones 108, 108′ may be polished to remove defects or contaminants, to reduce film thickness, and more generally to improve surface uniformity. The edge profile shown in FIG. 1A is substantially triangular in shape and may be approximated by identifying specific sections delimited by a plurality of nodes positioned on the edge 104. In particular, the profile of FIG. 1A may be characterized by a first node (N1) positioned at the conjunction of edge exclusion zone 108 and bevel 112, a second node (N2) positioned at the outer edge 110, and a third node (N3) positioned at the conjunction of edge exclusion zone 108′ and bevel 114. The three nodes N1, N2, N3 define two sections N1-N2 and N2-N3, which, in the example shown, constitute the flat bevels 112, 114.

FIG. 1B is a cross-sectional view of a second exemplary edge profile of a substrate 120 which may be produced by a different manufacturer, for example. Substrate 120 includes major surfaces 122, 122′ and an edge 124. The major surface 122, 122′ of the substrate 120 may include respective device regions 126, 126′ upon which devices may be fabricated, and exclusion regions 128, 128′ upon which device fabrication is not meant to occur. It is noted that the dimensions (e.g., width) of the device regions 126, 126′ and edge exclusion zones 128, 128′ may be different from the corresponding device regions 106, 106′ and edge exclusion zones 108, 108′ of the edge profile shown in FIG. 1A. This may be one way in which substrates 100, 120 may differ.

Additionally, the edge portion 124 of the substrate 120 shown in FIG. 1B may differ from the edge portion 104 of the substrate 100 shown in FIG. 1A, for example. As shown, the edge 124 includes bevels 130, 132, which may differ in length and angle from bevels 112, 114 of the edge 104. Additionally, the edge 124 may include, for example, two “flat” planar portions 135, 137 and a flat end surface 139. The two flat planar portions 135, 137 may (as depicted,) for example, be bevels inclined at a greater angle than bevels 130, 132. The flat end surface 139 may be oriented perpendicularly with respect to major surfaces 122, 122′. The edge profile shown in FIG. 1B may be more complex than the edge profile shown in FIG. 1A, in that a greater amount of information may be used to characterize the profile. In particular, the profile of FIG. 1B may be characterized by a first node (N11), positioned at the conjunction of edge exclusion zone 128 and bevel 130, a second node (N12), positioned at the conjunction of bevel 130 and planar portion 135, a third node (N13), positioned at the conjunction of planar portion 135 and end surface 139, a fourth node (N14), positioned at the conjunction of end surface 139 and planar portion 137, a fifth node (N15), positioned at the conjunction of planar portion 137 and bevel 132, and a sixth node (N16), positioned at the conjunction of bevel 132 and edge exclusion zone 128′.

While the sections of the profile may be used to define the nodes as indicated, in the absence of knowledge of the edge profile, the six nodes N11-N16 of the edge profile shown in FIG. 1B, may in turn define the five sections N11-N12, N12-N13, N13-14, N14-N15 and N15-16 of the edge profile of substrate 120. For example, with a small amount of additional information as to the shape of each of these sections (e.g., flat as shown) the corresponding portions, bevel 130, planar portion 135, end surface 139, planar portion 137 and bevel 132 may be reconstructed from the nodal information (e.g., the positions of nodes N11-N16).

During substrate processing, residual films may accumulate on the edges of the substrates. Polishing procedures may be used to remove such residual films. However, to properly remove the residual film without damaging the substrate or changing the substrate's edge profile, it is important to ascertain the substrate edge profile in order to adjust the polishing procedures accordingly. For example, through knowledge of the edge profile, the force and angle at which an abrasive polishing film may be applied to the substrate, and the speed at which the substrate is rotated, may be adjusted in accordance with the substrate edge profile.

For example, the edge profiles of the substrates 100, 120 shown in FIGS. 1A and 1B include planar surfaces oriented at different angles with respect to the major surfaces of the substrates 100, 120. Such planar surfaces may be polished by forcibly contacting the edges 104, 124 with an abrasive polishing tape at specific angles with respect to the major surfaces 102, 102′ and 122, 122′, respectively. Previously incorporated U.S. patent application Ser. Nos. 11/298,555 and 60/939,333 (Attorney Docket Nos. 10414, 11567) describe apparatus and methods for angularly translating a polishing head adapted to forcibly apply the polishing tape to the substrate 100, 120. In some embodiments, a polishing head may be coupled to a rotating arm such that the polishing tape may be oriented at a desired angle with respect to the major surfaces 102, 102′, 122, 122′.

Controlled angular translation of the polishing head may also enable curved edge profiles to be polished. Curved profiles (or portions thereof) may be polished, for example, by a continuous rotation and/or angular translation of a polishing head (and polishing tape) around a curved portion of the edge 104, 124. FIG. 1C is a cross-sectional view of a third exemplary edge profile of a substrate 140 including a curved portion. Substrate 140 includes major surfaces 142, 142′ and an edge 144. The major surface 142, 142′ of the substrate 140 may include respective device regions 146, 146′ upon which devices may be fabricated, and exclusion regions 148, 148′ upon which device fabrication is not meant to occur. As shown, the edge 144 includes bevels 150, 152. An outer portion 154 of the edge 144 includes a curved section 156. The edge profile of FIG. 1C may be characterized by a first node (N21), positioned at the conjunction of edge exclusion zone 148 and bevel 150, a second node (N22), positioned at the conjunction of bevel 150 and curved section 156, a third node (N23), positioned at the conjunction of curved section 156 and bevel 152, and a fourth node (N24), positioned at the conjunction of bevel 152 and edge exclusion zone 148′. The sections of the profile of substrate 140 include N21-N22, N22-N23 and N23-N24. In this case, section N22-N23 is curved.

According to the invention, nodal and sectional information, used to characterize one or more substrate edge profiles, may be included in a database (‘edge profile database’) which may be indexed using a substrate identification code, such that by looking up a particular substrate identification code, the edge profile characteristics of the associated substrate may be accessed.

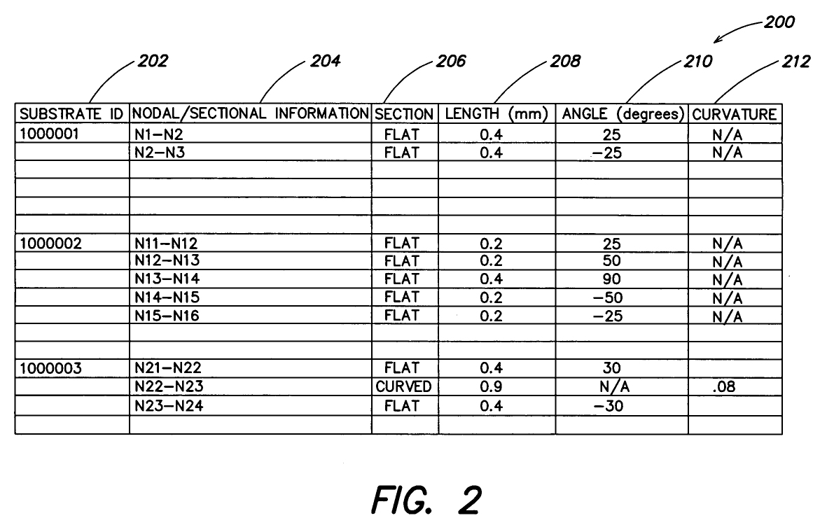

FIG. 2 illustrates an exemplary edge profile database 200 provided according to the present invention. It is noted that the values of length dimensions and angles listed are merely exemplary, and other suitable length dimensions and angles may be used. As shown, the database 200 includes several columns 202, 204, 206, 208, 210, 212, which each include information related to a particular field or parameter of the substrate and/or substrate edge profile. The first column 202 includes substrate identification codes which, as stated, may be used as an index since the codes uniquely identify particular substrates. In the database 200, three substrate identification codes 100001, 100002, 100003 are depicted, and accordingly the database 200 includes information pertaining to the three substrates 100001, 100002, 100003 thus identified. For illustrative purposes, in the exemplary database of FIG. 2, substrate 100001 corresponds to substrate 100 depicted in FIG. 1A, substrate 100002 corresponds to substrate 120 depicted in FIG. 1B, and substrate 100003 corresponds to substrate 140 depicted in FIG. 1C. The database 200 may include information pertaining to a smaller or larger number of substrates.

The second column 204 includes nodal/sectional information for each of the substrate identification code entries. This information may be similar to the nodal/sectional information discussed above with reference to FIGS. 1A-C. For example, the information in column 204 pertaining to substrate 100001 (corresponding to substrate 100 of FIG. 1A) lists three nodes N1, N2, N3 and two sections N1-N2, N2-N3 connecting the three nodes. Each section N1-N2, N2-N3 is allocated a separate row in column 204. Likewise, the information in column 204 pertaining to substrate 100002 (corresponding to substrate 120 of FIG. 1B) lists six nodes Nil, N12, N13, N14, N15, N16 and five sections N11-N12, N12-N13, N13-N14, N14-N15, N15-16 connecting the six nodes. Each of the sections N11-N12, N12-N13, N13-N14, N14-N15, N15-16 is similarly allocated a separate row in column 204. Similarly, the information in column 204 pertaining to substrate 100003 (corresponding to substrate 140 of FIG. 1C) lists four nodes N21, N22, N23, N24 and three sections N21-N22, N22-N23, N23-N24 connecting the four nodes. Each of the sections N21-N22, N22-N23, N23-N24 is similarly allocated a separate row in column 204. Accordingly, each substrate identification code 100001, 100002, 100003 may be allocated a plurality of rows corresponding to the number of sections in the edge profile of the identified substrate.

The third column 206 includes information characterizing the shape of the sections listed in column 204. For each section listed in column 204, the third column 206 indicates a shape of the corresponding section. The entries in the sectional shape field of column 206 are depicted in terms of simplified indicators, such as ‘flat’ and ‘curved,’ but other shape indicators may be used. For example, the sectional shape field of column 206 may indicate whether a curve is convex or concave (e.g., “convex curve”, “concave curve”). With respect to the substrates characterized in database 200, the third column 206 includes entries indicating that sections N1-N2, N2-N3 of substrate 100001 are flat, sections N11-N12, N12-13, N13-N14, N14-N15, N15-16 of substrate 100002 are flat, and that sections N21-N22, N23-N4 of substrate 100003 are flat, while section N22-N23 of substrate 100003 is curved.

The fourth column 208 includes information related to the length of sections listed in column 204. As listed, sections N1-N2, N2-N3 of substrate 100001 are 0.4 mm long, sections N11-N12, N12-13, N14-15, N15-N16 of substrate 100002 are 0.2 mm long, section N13-N14 is 0.4 mm long, sections N21-N22, N23-N4 of substrate 100003 is 0.4 mm long, and section N22-N23 is 0.9 mm long.

The fifth column 210 includes information related to the inclination angle of the sections listed in column 204 that are flat (and for which the inclination angle is well-defined). Column 210 includes entries indicating that sections N1-N2, N2-N3 of substrate 100001 are inclined at 25 and −25 degrees with respect to the major surfaces 102, 102′. With regard to substrate 100002, section N11-N12 is inclined at 25 degrees, section N12-13 is inclined at 50 degrees, section N13-N14 is inclined at 90 degrees, section N14-N15 is inclined at −50 degrees, and section N15-16 is inclined at −25 degrees with respect to major surfaces 122, 122′. With regard to substrate 100003, section N21-N22 is inclined at 30 degrees, and section N23-N24 is inclined at −30 degrees.

The sixth column 212 includes information related to the curvature of the sections listed in column 204 that are curved. The curvature may be a normalized parameter that indicates the degree of curvature of the section. In the database depicted characterizing substrates 100, 120 and 140, the only curved section is N22-N23 on the edge 144 of substrate 140, which has a curvature value of 0.8.

It is to be appreciated that additional and/or different fields may be included in the database 200. For example, the edges 104, 124, 144 of respective substrates 100, 120, 140 may have distinct profiles at different points on their circumferences. For example, a portion of one or more of edges 104, 124, 144 may comprise a notch which may have a quite different profile in comparison to other portions of the edge 104, 124, 144. In such cases, a substrate identification code may be associated with more than one edge profile, and in turn, a particular edge profile may be associated with a range of angular values (e.g., stored in an additional sub-field) on the circumference of the substrate 100, 120, 140.

As stated, according to the invention, the edge profile information within database 200 may be provided to an edge polishing apparatus so that the polishing ‘recipe’ used on a particular substrate can be tailored to the characteristics of the edge profile of the particular substrate. In some embodiments, the edge profile information may be provided to the edge polishing apparatus via a controller, as further described below.

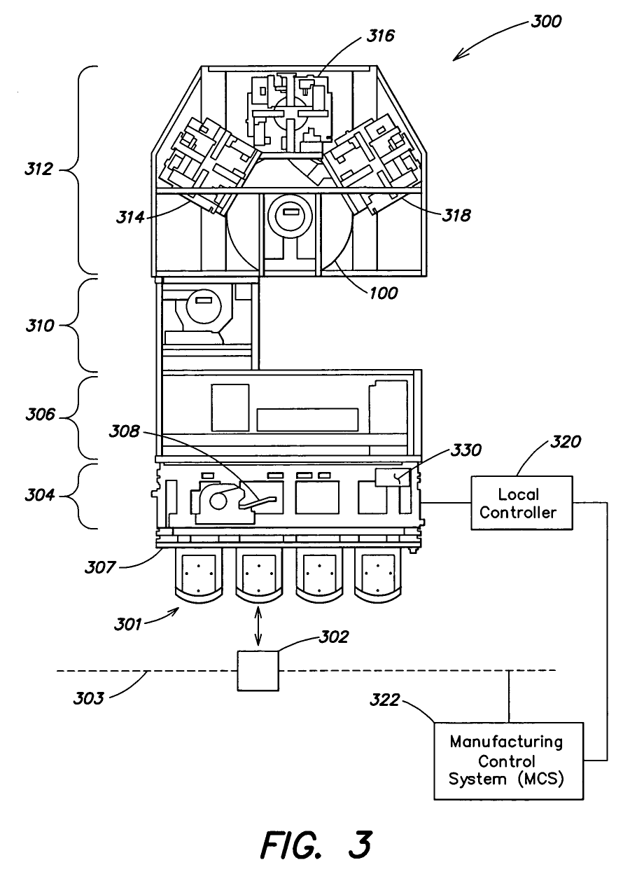

Turning to FIG. 3, an exemplary substrate cleaning and polishing system 300 is shown. The system 300 comprises a substrate loading/unloading station 301 from which the cleaning and polishing system 300 may receive substrate carriers (e.g., 302) from other parts of a manufacturing facility and to which the cleaning and polishing system 300 may return cleaned and/or polished substrates to the manufacturing facility. The substrate carriers 302 may be configured to hold a single substrate or more than one substrate (e.g., up to 25 substrates). The substrate carriers 302 may be carried through the manufacturing facility along a conveyor 303, which may, for example, be continuously moving, to and from the loading/unloading station 301. The conveyor 303 may be of a vertical ribbon type disclosed in previously incorporated U.S. patent application Ser. No. 10/764,982, entitled “Methods and Apparatus for Transporting Wafer Carriers” (Attorney Docket No. 7163).

The loading/unloading station 301 may be of the type disclosed in previously incorporated U.S. patent application Ser. No. 10/650,479, entitled “Method and Apparatus for Supplying Substrates to a Processing Tool” (Attorney Docket No. 7096), in which substrate carriers 302 are moved directly to docking ports on the station instead of to storage shelves, although other types of loading/unloading stations 301 may be used.

A factory interface (FI) 304 may be positioned between the loading/unloading station 301 and a cleaning tool 306. The loading/unloading station 301 is positioned adjacent a first ‘factory’ side of a clean room wall 307 and the factory interface 304 is positioned adjacent a second ‘system’ side of the clean room wall 307. The factory interface 304 may include a robot 308 that may move horizontally along a track (not shown) parallel to the clean room wall 307. The robot 308 may engage docking ports of the loading/unloading station 301 to remove unprocessed substrates from, or provide processed (i.e., cleaned and/or polished) substrates to, the loading/unloading station 301 via a sealed space such as a slit valve (not explicitly shown). The robot 308 may also transport substrates to and from the cleaning tool 306.

The cleaning tool 306 may comprise one or more vertical or horizontal cleaning modules, including, for example: a megasonic cleaner, a cleaning bath, a rinsing module, a vapor drying module (e.g., Marangoni dryer), a brush scrubber, and a spin-rinse dryer. The vapor drying modules may be of the type disclosed in U.S. patent application Ser. No. 10/764,982, entitled “Methods and Apparatus for Transporting Wafer Carriers” (Attorney Docket No. 5877). The cleaning tool 306 may be equipped with an internal transfer chamber having a robot (not shown), and the cleaning modules may be arranged in a plurality of bays around the transfer chamber, in which the bays may be adapted to support either vertical or horizontal cleaning modules as described in U.S. provisional patent application No. 60/882,066, entitled “Systems and Methods for Modular and Configurable Substrate Cleaning” (Attorney Docket No. 10860/L). The cleaning tool 306 and cleaning modules therein may be configured in other ways.

The cleaning tool 306 may be coupled to a polishing tool 312 via a transfer chamber 310, which may include a robot adapted to transfer substrates, such as substrate 100, between the cleaning tool 306 and the polishing tool 312.

The polishing tool 312 may include one or more bevel and/or notch polishing apparatuses (e.g., 314, 316, 318) as described, for example, in previously incorporated U.S. patent application Ser. No. 11/298,555 and U.S. provisional patent application No. 60/939,333(Attorney Docket No. 11567/L). For example, as described in the latter application, polishing apparatuses 314, 316, 318 may comprise movable and rotatable polishing arms that apply an abrasive polishing tape against the edge of a substrate 100 via a polishing head positioned on the polishing arm. As shown, the polishing tool 312 includes three (3) polishing apparatuses 314, 316, 318 positioned around the circumference of the substrate 100. A smaller or larger number of apparatuses may be used (e.g., 1, 2, 3 . . . n). In accordance with the invention, each polishing apparatus 314, 316, 318 may be directed to execute a selected processing recipe. The selected recipe may involve, for example, precisely controlling the position and motion of components, such as polishing heads of the polishing apparatuses 314, 316, 318, so as to apply the abrasive polishing tape at specific locations, angles, and pressures to the edge 104 of the substrate 100.

The components of the cleaning and polishing system 300, including the loading/unloading station 301, the factory interface 304, the cleaning tool 306, the transfer chamber 310 and the polishing tool 312 may be operated under the control of a local controller 320. The local controller 320 may be or may include any components or devices which are typically used by, or used in connection with, a computer or computer system. Although not explicitly pictured in FIG. 3, the local controller 320 may include one or more central processing units, read only memory (ROM) devices and/or random access memory (RAM) devices. The local controller 320 may also include input devices such as a keyboard and/or a mouse or other pointing device, and output devices such as a printer or other device via which data and/or information may be obtained, and/or a display device such as a monitor for displaying information to a user or operator. The local controller 320 may also include a transmitter and/or a receiver such as a LAN adapter or communications port for facilitating communication with other system components (as described further below) and/or in a network environment, one or more databases for storing any appropriate data and/or information, one or more programs or sets of instructions for executing methods of the present invention, and/or any other computer components or systems, including any peripheral devices.

The local controller 320 may be coupled (e.g., logically or electronically) to a manufacturing execution system (MCS) 322. The MCS 322 may comprise a host computer system coupled to a local or wide array network and associated data storage resources (e.g., hard disk, optical disk, network-assisted storage, dedicated database servers, etc.) The MCS 322 may execute a manufacturing execution system (MES) that monitors operations of an electronic device manufacturing facility. In particular, the MES may also be coupled to a transport system controller (TSC) (not shown) that maintains the operation of the transport system including the conveyor 303. In addition, the MCS 322 may keep track of substrate carriers as they are moved through different tools in the facility such that any given time, the MCS 322 can determine the location of any and all substrate carriers within the facility. As described in previously incorporated U.S. patent application Ser. No. 10/440,937 (issued as U.S. Pat. No. 6,954,711), the MCS 322 may store the substrate identification code of the substrates being processed in the manufacturing facility, and may also store an identification of a substrate carrier (e.g., 302) in which each substrate is stored. The MCS 322 may also store and/or have access to a database storing the processing history of each of the identified substrates. According to the invention, the MCS 322 may also store and/or have access to edge profile data (e.g., database 200) for each identified substrate.

The information within such databases may be updated in real time via data communication with the various processing units within the manufacturing facility. In this manner, as substrate carriers are conveyed throughout the facility between different processing tools, the substrates being carried within each substrate carrier, and the current processing state of each substrate within each carrier, may be monitored.

In some embodiments of the present invention, the MCS 322 may communicate substrate information to a local controller of a processing unit (e.g., local controller 320 of cleaning and polishing system 300). This may be done automatically when substrates intended to be cleaned and/or polished are approaching the cleaning and polishing system 300. For example, as a substrate carrier 302 approaches the system 300 for a loading operation in which substrates (e.g., 100) are provided to the system 300 for further processing, the MCS 322 may communicate information regarding each of the substrates stored in the substrate carrier 302 to the local controller 320. The MCS 322 may communicate the substrate information to the local controller 320 at other times, for example, after a substrate carrier 302 is received at the loading/unloading station 301 of the cleaning and polishing system 300.

The information provided by the MCS 322 may include the information in the edge profile database 200. In this manner, the local controller 320 may obtain edge profile information regarding each of the substrates in the substrate carrier 302. For each individual substrate (e.g., 100) processed in the cleaning and polishing system 300, the local controller 320 may determine and select a suitable processing recipe based on the edge profile information (and possibly additional information such as the substrate's processing history), and may control the polishing tool 312 according to the selected recipe. By tailoring the processing recipe to the profile edge of each substrate, greater uniformity in end results may be achieved.

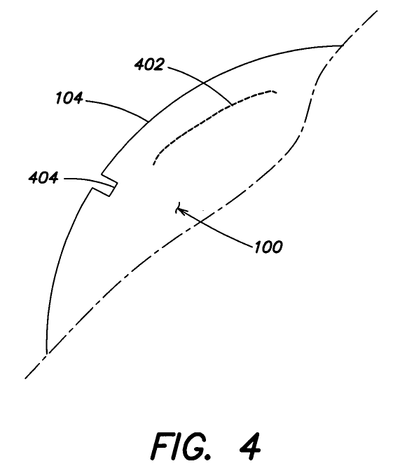

According to alternative embodiments of the invention, the MCS 322 may not transmit substrate information such as identification information or edge profile information (e.g., database 200), to the local controller 320. Instead, the local controller 320 may identify substrates provided to the cleaning and polishing system 300 using other techniques. For example, one or more substrates may be inscribed with one or more unique identification codes, which may be used to identify the substrates. FIG. 4 shows a portion of a surface of a substrate (e.g., 100) having an exemplary identification code 402 located proximate to the edge 104 of the substrate 100. The identification code 402 may include bar codes, alphanumeric characters, or any other suitable markings that are readily detectable and adapted to uniquely identify the substrate 100. The identification code 402 may be the same as or correspond to the substrate identification code (i.e., 100001) of the substrate 100 stored in the edge profile data database 200. As shown, the identification code 402 may be positioned in fixed relation to a notch 404 or other orientation features on the edge 104 of the substrate 100 which may facilitate robotic and or other handling of the substrate 100.

Referring again to FIG. 3, the cleaning and polishing system 300 may include an optical detection device 330, such as a scanner, for example, adapted to read the substrate identification code 402 inscribed on the surface of the substrate 100. As shown, the optical detection device 330 is located in the factory interface 304, but this is merely exemplary, and the optical detection device 330 may be positioned in other locations within the cleaning and polishing system 300, such as the loading/unloading station 301, or in locations external to the cleaning and polishing system 300. The optical detection device 330 may be coupled to the local controller 320 and may supply the latter with optical detection signals. The local controller 320 may process the optical detection signals to determine the identification code 402 (e.g., alphanumeric code) inscribed on the substrate 100.

Upon a determination of the substrate identification code 402 of the received substrate 100, the local controller 320 may send a signal to the MCS 322 in order to obtain edge profile information stored in the database 200 corresponding to the determined substrate identification code 402. The MCS 322 may access and retrieve the edge profile information in the database 200 corresponding to the identification code 402, and may then transmit the edge profile information back to the local controller 320. The local controller 320 may then determine an edge polishing recipe for the substrate 100 based on the edge profile information received from the MCS 322.

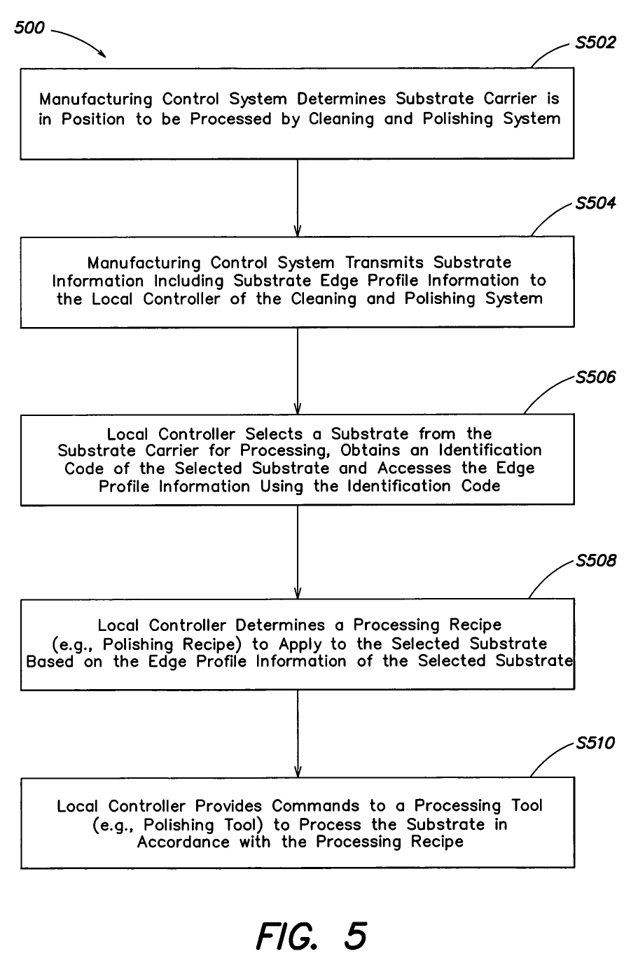

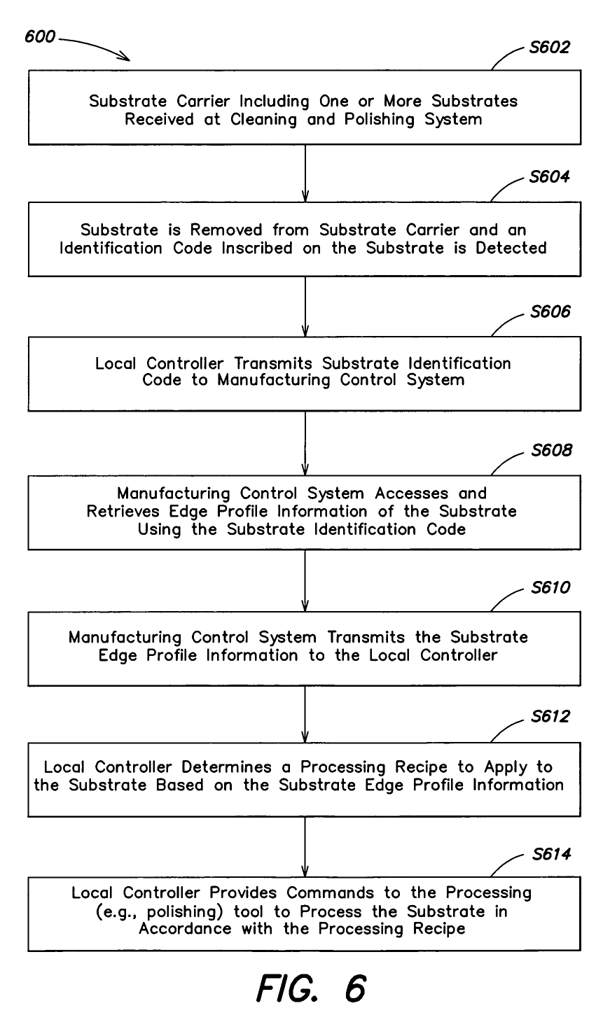

FIGS. 5 and 6 are flow charts of exemplary alternative methods of processing a substrate, including identifying the edge profile of a substrate, and processing the substrate based on the edge profile, according to the invention. FIG. 5 is a flow chart of a first method 500 for processing a substrate in which a central controller (e.g. MCS 322) automatically provides database information to the local controller 320 of the cleaning and polishing system 300. FIG. 6 is a flow chart of a second method 600 for processing a substrate in which the local controller 320 identifies the substrate and then obtains edge profile information on the identified from the MCS 322.

Referring to FIG. 5, the method 500 of processing a substrate is shown. In step S502, the manufacturing control system (MCS) 322 of the electronic device manufacturing facility determines that a substrate carrier 302, including one or more substrates scheduled to be processed at a cleaning and polishing system 300, is in position to be processed by the cleaning and polishing system 300. In step S504, the MCS transmits information to the local controller 320 of the cleaning and polishing system 300. The information provided by the MCS 322 to the local controller 320 may include the information in the edge profile database 200 described above with respect to FIG. 2, i.e., substrate identification codes of the substrates present in the substrate carrier 302 and edge profile information of each of the substrates indexed according to the substrate identification codes.

Upon receipt of the edge profile information from the MCS 322, in step S506, the local controller 320 selects a substrate for processing, and accesses the received edge profile information of the substrate based on the substrate's identification code. In step S508, the local controller 320 determines a polishing recipe to apply to the selected substrate, based on the edge profile information associated with the selected substrate. In step S510, the local controller 320 provides commands to the polishing tool 312 to process the substrate in accordance with the polishing recipe.

Referring now to FIG. 6, an exemplary flow chart of an alternative method 600 of processing a substrate is provided. In step S602, the cleaning and polishing system 300 receives a substrate carrier 302, including one or more substrates, In step S604, a substrate is removed from the substrate carrier 302 and a substrate identification code 402 inscribed on the surface of the substrate is detected (e.g., by an optical detection device, for example) and read. The local controller 320 then transmits, in step S606, a request to the MCS 322 to obtain edge profile information associated with the substrate, the request including the identification code 402 of the substrate. In step S608, the MCS 322 accesses an edge profile information database and retrieves the edge profile information associated with the substrate, using the substrate identification code 402. The MCS 322 then transmits the edge profile information associated with the substrate to the local controller 320 in step S610. In step S612, the local controller 320 determines a polishing recipe to apply to the substrate, based on the edge profile information. Then in step S614, the local controller 320 provides commands to the polishing tool 312 to process the substrate in accordance with the polishing recipe.

The foregoing description discloses only exemplary embodiments of the invention. Modifications of the above disclosed apparatus and methods which fall within the scope of the invention will be readily apparent to those of ordinary skill in the art. For instance, although the inventive methods herein have been described with reference to a cleaning and polishing system, the concepts apply equally to stand alone tools (e.g., a stand-alone polishing tool). Furthermore, other electronic device manufacturing processes may be sensitive to differences in substrate edge profiles. The methods described herein may be applied to these other processes, for example, to identify edge profiles of substrates and to provide processing recipes tailored to specific substrate edge profiles.

Additionally, although only examples of cleaning a round substrate are disclosed, the present invention could be modified to clean substrates having other shapes (e.g., a glass or polymer plate for flat panel displays). Further, although processing of a single substrate by the apparatus is shown above, in some embodiments, the cleaning and polishing system may process a plurality of substrates concurrently.

Accordingly, while the present invention has been disclosed in connection with exemplary embodiments thereof, it should be understood that other embodiments may fall within the spirit and scope of the invention, as defined by the following claims.

The invention claimed is:

1. A method of processing a substrate comprising:
receiving substrate information at a substrate processing system wherein the substrate information is associated with at least one substrate;
determining an identification code of a substrate selected for processing using the received substrate information;
retrieving edge profile information associated with the selected substrate from the received substrate information using the identification code of the selected substrate; and
determining a processing recipe for the selected substrate based on the retrieved edge profile information.

2. The method of claim 1 further comprising:
determining the selected substrate is in position to be processed.

3. The method of claim 1 further comprising:
providing commands to a polishing tool to process the substrate in accordance with the processing recipe.

4. The method of claim 3 further comprising:
processing the substrate in accordance with the processing recipe.

5. The method of claim 1 wherein the substrate information is received from a manufacturing control system.

6. The method of claim 1 wherein the identification code uniquely identifies a particular substrate.

7. The method of claim 1 wherein the edge profile information includes node section information.

8. A method of processing a substrate having an edge profile and an inscribed identification code, the method comprising:
receiving a substrate at a substrate processing system;
detecting an inscribed identification code of the substrate;
transmitting a request, including the identification code of the substrate, to access stored edge profile information associated with the substrate;
receiving the stored edge profile information associated with the substrate; and
determining a processing recipe for the substrate based on the edge profile information of the substrate.

9. The method of claim 8 further comprising:
determining the processing recipe for the substrate based on the edge profile information of the substrate and the substrate processing history.

10. The method of claim 8 further comprising:
providing commands to a polishing tool to process the substrate in accordance with the processing recipe.

11. The method of 10 further comprising:
processing the substrate in accordance with the processing recipe.

12. The method of claim 8 wherein the edge profile information includes node section information.

13. The method of claim 12 wherein the node section information includes information characterizing the shape of the node sections.

14. A system for processing a substrate comprising:
an edge profile database containing substrate edge profile information;
an edge polishing apparatus adapted to polish the edge of the substrate; and
a controller adapted to receive the edge profile information from the edge profile database, and further adapted to instruct the edge polishing apparatus to process the substrate edge in accordance with the edge profile information.

15. The system of claim 14 wherein the edge profile database includes at least one substrate identification code.

16. The system of claim 15 wherein the substrate identification code uniquely identifies a substrate.

17. The system of claim 15 wherein the identification code is inscribed on a surface of the substrate.

18. The system of claim 17 further comprising an optical detection device.

19. The system of claim 18 wherein the optical detection device is adapted to read the identification code inscribed on the surface of the substrate.

20. The system of claim 15 wherein the edge profile database includes node section information associated with the substrate identification code.

21. The system of claim 20 wherein the node section information includes information characterizing the shape of the node sections.

22. The system of claim 20 wherein the node section information includes information related to the length of the node sections.

23. The system of claim 20 wherein the node section information includes information related to the inclination angle of the node section.

24. The system of claim 23 wherein the inclination angle is the angle of inclination of the node section with respect to a major surface of the substrate.

25. The system of 20 wherein the node section information includes information related to the curvature of the node section.
